(19) United States
(12) Patent Application Publication
(10) Pub. No.: US 2004/0170273 A1
(43) Pub. Date: Sep. 2, 2004

(54) Coding method, particularly a numeric coding method

(76) Inventors: Luigi Carabiniere, Milano (IT); Pierluigi Mirto, Milano (IT); Giancarlo Formicuccia, Milano (IT)

Correspondence Address: Hunton & Williams, 1900 K Street NW, Washington, DC, 20006-1109, US

(21) Appl. No.: 10/479,227

(22) PCT Filed: May 13, 2002
(86) PCT No.: PCT/IT02/00314

(30) Foreign Application Priority Data
Jun. 1, 2001 (IT) RM2001A000304

(51) Int. Cl. H04L 9/00

(52) U.S. Cl. 380/28

(57) ABSTRACT

An apparatus and method for encoding an input string A into an output string B, whose items aₙ and bₙ belong to an alphabet S of M symbols sₘ, the method being characterised by providing an ordered arrangement of the M symbols sₘ of the alphabet S, by performing a scanning operation on the items aₙ of the input string A and in that, for each of the items aₖ, where k ε{0, 1, . . . , N−1}, it includes arranging in decreasing order in an ordered arrangement vector O (whose items oⱼ include the indexes i of items ƒᵢ) the M items ƒᵢ of an occurrence vector F of the symbols sₘ of the alphabet S in at least a portion Wₖ⊂A of Tₖ items, establishing a permutation vector P consisting of M items pₜ, whose items are such as to fulfil the following relationship pₒ_{ⱼ}=j and assigning to item bₖ of the output string B the symbol bₖ=S_{E}(ₕ_{_{Pt=w}}) where w is the w-th index h_{w} of the ordered succession H such as to fulfil the relationship aₖ=Sₕ_{_{w}} and the enciphering function E(m) is an invertible function whose dominion and co-dominion are coinciding.

### RELATED APPLICATIONS

This application is a United States National Phase application based on PCT/IT02/00314 which was filed on May 22, 2002 entitled “A Coding Method, Particularly a Numeric Coding Method” the subject matter of which is hereby incorporated by reference in its entirety. In addition, PCT/IT02/00314 was based on Italian Patent Application No. RM2001A000304 filed on Jun. 1, 2001, the entirety of which is also incorporated by reference.

### FIELD OF THE INVENTION

This invention broadly relates to an encoding method and to the corresponding decoding method.

More particularly, this invention relates a encoding method and to a corresponding decoding method that, when preferably applied to binary strings, allow to unbalance or to balance, respectively, the occurrence distributions of “1” and “0” in the coded string with respect to the distributions of the starting strings. The methods according to this invention appear to be simple and unexpensive to be exploited, entail a low processing burden and, consequently, are advantageously applicable to digital compression methods, in order to increase the compression ratios and can be exploited as cryptographic methods.

This invention further relates to the instruments to perform the method as well as to the apparatuses to execute the method.

It is known that one of the main problem in computer technology is related to the ever increasing amount of data items needed for processing. This entails a large expenditure of the computer memory resources as well as an extended engagement of the telecommunications networks during the information transmission, which, in turn, entails a higher transmission error probability.

Various approaches have been developed to solve such problems by providing for encoding the data, in binary representation, according to suitable methods aimed at reducing the expenditure extent of the memory resources.

Among these compression methods, the arithmetic compression methods are in principle very effective because they furnish a compression value which is very close to the theoretical limit defined by the entropic computation method of Shannon. Such methods have a computation complexity proportionally increasing with the balance of the binary string to be compressed, namely the complexity increases with increasing balance of the “1” and “0” occurrence distribution in the string to be compressed. Furthermore, the more the string to be compressed is balanced, the less efficient the compression method turns out to be, thereby reaching low ratio values. The computational complexity noticeably limits the application of the arithmetic compression methods, because it entails a noticeable expenditure of the resources in the computer performing the compression as well as long processing times and a poor efficiency in balanced strings.

A further problem faced by the inventions in the development of this invention is related to cryptography.

The presently existing cryptographic systems provide for use of a key for encoding and/or decoding data. The most simple cryptographic systems are all based upon use of a “symmetric key” method, in which the same key is utilised for the whole encoding/decoding process. Other more powerful and safer systems are based upon use of an “asymmetric key” method, in which the encoding key is different from the decoding key.

The weakness point of these systems is the information exchange needed for encoding and decoding the data. In fact, when a message is to be delivered, it is to be encoded and transmitted and the utilised key is also to be communicated to the addressee in order to enable the addressee to correctly decode the received message.

A drawback of these systems, both the ones based upon use of a symmetric key and the ones based upon use of an asymmetric key, is related to the fact that the utilised key is to be communicated.

In fact, should an intruder succeed in intercepting the concerned key, upon getting the document in his/her hands he/she would have no difficulty in decoding the contents.

Furthermore, even if the cryptographic key is not known, it is always possible to decode the message by following a trial and error procedure, also known as “Reverse Engineering”. In fact, almost all file typologies include an initial portion, designated as “header”, having an extension of a few bytes which unambiguously identifies them (for instance, all acoustic files with extension “wav” start with an ASCII value “RIFF4”). This means that if an undefined series of attempts to decode the message are carried out by varying the key at each attempt, it is possible to identify the utilised cryptographic key by recognition of a header of an already known file typology. This appears to be easier when also the file type to be decoded and consequently the header to be identified are known. Obviously, upon identifying the key, the intruder is enabled to decode any information encoded by that key.

### SUMMARY OF THE INVENTION

It is an object of this invention, therefore, to provide a method for encoding strings, particularly for numerically encoding binary strings, which allows in simple, rapid and unexpensively implementable way to unbalance the occurrence distribution of “1” and “0” of the encoded string.

It is also an object of this invention to provide a decoding method, in particular a numeric decoding method, which enables to balance the occurrence distribution of “1” and “0” of a decoded binary string and which correspondingly enables to decode a binary string encoded by means of the numeric encoding method.

In view of the correspondence between such encoding and decoding methods, it is apparent that, according to the application type, their roles can be inverted, so that a binary string can be preliminarily processed by the decoding method and the resulting string can be subsequently processed by the encoding method, in order to recover the starting string.

It is a further object of this invention to provide the above encoding and decoding methods, particularly numeric encoding and decoding methods, such that no information item is lost in processing the strings, the methods turning out to be therefore lossless.

It is an other object of this invention to provide a method adapted to perform, on a binary string corresponding to a document, an information mixing action in order to make the contents of the document itself useless to any Reverse Engineering purpose of the encoded document.

Also an object of this invention is to furnish the above encoding and decoding methods such that they are iteratable.

A further object of this invention is to provide instruments needed to perform the methods and the apparatuses performing the methods themselves.

It is specific subject matter of this invention to provide a method for encoding an input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the method being characterised in that it includes the following preliminary step:

A. providing an ordered arrangement of the M symbols sₘ of the alphabet S as represented by a corresponding ordered succession H={hₗ, where l=1, . . . , M−1} of the indexes m, such that

hₗε{0, 1, . . . M−1}

h_{q}≠hᵣ for q≠r;

in that a scanning operation is carried out on items aₙ of the input string A and in that, for each of the items aₖ, where k ε{0, 1, . . . , N−1}, it includes the following steps:

B. arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:

$${\sum }_{i = 0}^{M - 1} {f}_{i} = {T}_{k} ,$$

the items ƒᵢ of the occurrence vector F (each of which, in other words, is one-to-one correspondence to the symbol sₘ of the alphabet S in respect of which hᵢ=m) being arranged in an arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the ordered arrangement of the symbols sₘ of the alphabet S, as represented by the corresponding ordered arrangement H, such that

ƒₒ_{ₓ}≧ƒₒ_{_{y}}, ∀y>x

and

for ƒₒ_{_{z}}=ƒₒ_{_{z+1}}, o_{z}=u<v=o_{z+1},

where

H={h₀, . . . , hᵤ, . . . , hᵥ, . . . , h_{M-1}}

C. establishing a permutation vector P consisting of M items pₜ, where t=0, 1, . . . , M−1, whose items are such as to fulfil the following relationship

pₒ_{ⱼ}=j for j=0, 1, . . . , M−1

and

D. assigning to item bₖ of the output string B the symbol

bₖ=S_{E}(ₕ_{_{pt=w}})

where w is the w-th index h_{w} of the ordered succession H such as to fulfill the relationship

aₖ=sₕ_{_{w}}

and the enciphering function E(m) is an invertible function whose dominion and co-dominion are coinciding and are equal to the assembly {0, 1, . . . , M−1}:

$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

According again to this invention, the at least a portion Wₖ of Tₖ items aₙ of the input string A can be different by at least two items aₖ_{₁} and aₖ_{₂} as scanned in the input string A.

Still according to this invention, the number Tₖ of items aₙ belonging to the at least a portion Wₖ is different by at least two items aₖ_{₁} and aₖ_{₂} as scanned in the input string A.

Further according to this invention, the method can also include, prior to the scanning operation, the following step:

E. zeroing the M items ƒᵢ, where i=1, . . . , M−1, of the occurrence vector F:

ƒᵢ=0, for i=0, 1, . . . , M−1.

Again according to this invention, for each of the items aₖ, with k ε{(0, 1, . . . , N−1} it further includes the following step:

F. up-dating the occurrence vector F.

Again according to this invention, the number Tₖ of items aₙ belonging to the at least a portion Wₖ is not higher than a constant value T for all items aₖ, where k ε{0, 1, . . . , N−1}, as scanned by the input string A:

Tₖ≦T,

where

k=0, 1, . . . , N−1.

Preferably according to this invention, the at least a portion Wₖ is a sub-string (or a window) of Tₖ consecutive items aₙ of the input string A. More preferably, the last item is the item aₖ₋₁ preceding the scanned item aₖ:

Wₖ={a_{k-T}ₖ,a_{k-T}ₖ+1, . . . , aₖ₋₁}.

In this case, the up-dating operation of the occurrence vector F, subsequently to computing the scanned item bₖ of the output string B, can be performed by decreasing the item ƒ_{w1} whose index w1 fulfils the relationship

aₖ₋ₜ_{ₖ}=sₕ_{_{w1}},

and by increasing the item ƒ₂ whose index w2 fulfils the relationship

aₖ=sₕ_{_{w2}}.

Further according to this invention, the number Tₖ of items aₙ belonging to the at least a portion Wₖ is constant for all items aₖ, where k ε{0, 1, . . . , N−1}, as scanned in the input string A:

Tₖ=T,

where

k=0, 1, . . . , N−1.

Again according to this invention, for at least one of the scanned items aₖ, the at least a portion Wₖ coincides with the input string A:

Wₖ=A.

Preferably according to this invention, the scanning operation of the items aₖ of the input string A is progressive, so that items aₖ, where k=0, 1, . . . , N−1, are successively scanned.

Still according to this invention, the items aₙ of the input string A belong to a sub-assembly S_{A} of the alphabet S, such that S_{A}⊂S, and the items bₙ of the output string B belong to a sub-assembly S_{B} of the alphabet S, such that S_{B}⊂S, the sub-assembly S_{A} being different from the sub-assembly S_{B}:

S_{A}≠S_{B}.

Preferably according to this invention, the enciphering function E(m) is a function with memory, so that the n-th computed value gₙ=E(m) depends on Z previously computed values:

gₙ=E(m, gₑ_{₁}, gₑ_{₂}, . . . , gₑ_{_{Z}}),

where Z≧1.

Further according to this invention, the enciphering function E(m) can be a pseudo-random value generating function.

Still according to this invention, the enciphering function E(m) is the identity function:

g=E(m)=m.

Preferably according to this invention, the input string A and the output string B are binary strings, the symbols sₘ of the alphabet S being binary symbols comprising L bits, where L≧1.

Again according to this invention, the indexes hₗ of the ordered succession H have a binary representation.

Preferably according to this invention, the indexes hₗ of the ordered succession H are equal to the corresponding symbol sₗ of the alphabet S:

hₗ=sₗ.

Further according to this invention, the indexes i of the items ƒᵢ of the occurrence vector F as well as the indexes j of the items oⱼ of the ordering vector O have a binary representation.

Preferably according to this invention, the indexes i of the items ƒᵢ of the occurrence vector F as well as the indexes j of the items oⱼ of the ordering vector O belong to the alphabet S.

It is further object-matter of this invention a method for decoding an input string B into an output string A, both the input string B and the output string A comprising N items, respectively, bₙ and aₙ, where n=0, 1, . . . , N−1, with items bₙ and aₙ belonging to an alphabet S of M symbols sₘ, where m=0, 1, . . . , M−1, the method being characterised in that it includes the following preliminary step:

G. providing an ordered arrangement of the M symbols sₘ of alphabet S represented by a corresponding ordered succession H={hₗ, where l=0 1, . . . , M−1} of the indexes m, such that

hₗε{0,1, . . . , M−1}

h_{q}≠hᵣ, for q≠r,

in that a scanning operation of items bₙ of the input string B is carried out and in that, for each of the items bₖ, where k ε{0,1, . . . , N−1}, it includes the following steps:

H. arranging in decreasing order the M items ƒᵢ, where i=0, 1, . . . , M−1, of an occurrence vector F of the symbols sₘ of the alphabet S in at least a portion Wₖ⊂A of Tₖ previously calculated items aₙ of the output string A, where Tₖ≧0, each items ƒᵢ being equal to the number of occurrences in portion Wₖ of the corresponding symbol sₕ_{ᵢ}, in respect of which the following relationship is fulfilled:

$${\sum }_{i = 0}^{M - 1} {f}_{i} = {T}_{k} ,$$

the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that

ƒₒ_{ₓ}≧ƒₒ_{_{y}}, ∀y>x

and

for ƒₒ_{_{z}}=ƒₒ_{_{z+1}}, o_{z}=u<v=o_{z+1},

where

H={h₀, . . . , hᵤ, . . . , hᵥ, . . . , h_{M-1}}

and

J. assigning to item aₖ of the output string A the symbol

aₖ=s_{D}(ₕ_{_{oj=w}})

where w is the w-th index h_{w} of the ordered succession H such as to fulfill the relationship

bₖ=sₕ_{_{w}}

and the deciphering function D(g) is an function whose dominion and co-dominion are coinciding and are equal to the assembly {0, 1, . . . , M−1}:

$$\{ \begin{matrix}m = D ( g ) ∈ \{ 0 , 1 , … , M - 1 \} \\ g = E ( m ) = {D}^{- 1} ( m ) = ∈ \{ 0 , 1 , … , M - 1 \}\end{matrix} .$$

The decoding method according to this invention can provide that the at least a portion Wₖ of Tₖ items aₙ of the output string A is different by at least two items bₖ_{₁} and bₖ_{₂} as scanned in the input string B.

Still in the method according to this invention, the number Tₖ of items aₙ belonging to the at least a portion Wₖ can be different by at least two items bₖ_{₁} and bₖ_{₂} as scanned in the input string B.

The decoding method according to this invention can further include, prior to the scanning, the following step:

K. zeroing the M items ƒi, where i=1, . . . , M−1, of the occurrence vector F:

ƒi=0, for i=0, 1, . . . , M−1.

Still according to this invention, for each of the items bₖ, with k ε{0, 1, . . . , N−1}, the decoding method can further include the following step:

L. up-dating the occurrence vector F.

Furthermore, in the method according to this invention, the number Tₖ of items aₙ belonging to the at least a portion Wₖ can be no higher than a constant value T for all items bₖ,

where k ε{b 0, 1, . . . , N−1}, as scanned by the input string B: Tₖ≦T, where k=0, 1, . . . , M−1.

Preferably, in the method according to this invention, the at least a portion Wₖ is a sub-string or window of Tₖ consecutive items aₙ of the output string A.

Still according to this invention, in the decoding method, the at least a portion Wₖ can be a sub-string of Tₖ consecutive items aₙ of the output string A whose last item is the item aₖ₋₁ as calculated for the scanned item bₖ preceding the scanned item bₖ of the input string B:

Wₖ={a_{k-T}_{ₖ},a_{k-T}_{ₖ}₊₁, . . . , aₖ₋₁}.

Again in the decoding method according to this invention, the number Tₖ of items aₙ belonging to the at least a portion Wₖ can be constant for all items bₖ, where k ε{0, 1, . . . , N−1}, as scanned in the input string B:

Tₖ=T,

where

k=0, 1, . . . , N−1.

Preferably according to this invention, the decoding method performs the scanning operation of items bₙ of the input string B in progressive mode, so that items bₖ where k=0, 1, . . . , N−1 are successively scanned.

Further according to this invention, the decoding method can provide for the items bₙ of the input string B to belong to a sub-assembly S_{B} of the alphabet S, such that S_{B}⊂S, and the items aₙ of the output string A belong to a sub-assembly S_{A} of the alphabet S, such that S_{A}⊂S, the sub-assembly S_{B} being different from the sub-assembly S_{A}:

S_{B}≠S_{A}.

Preferably according to this invention, the deciphering function D(g) as exploited in the decoding method is a function with memory, so that the n-th computed value mₙ=D(g) depends on J previously computed values:

mₙ=D(g, m_{c}_{₁}, m_{c}_{₂}, . . . , m_{c}_{ⱼ}),

where J≧1.

Still according to this invention, the deciphering function D(g) can be the inverse function of a pseudo-random value generating function.

Again according to this invention, the deciphering function D(g) can be the identity function:

m=D(g)=g.

Preferably according to this invention, the input string B and the output string A are binary strings, the symbols sₘ of the alphabet S being binary symbols comprising L bits, where L≧1.

Further according to this invention, the decoding method can provide for the indexes hₗ, of the ordered succession H to have a binary representation and particularly to be equal to the corresponding symbol sₗ of the alphabet S:

hₗ=sₗ.

Still according to this invention, the decoding method can provide for the indexes i of the items ƒᵢ of the occurrence vector F as well as the indexes j of the items oⱼ of the ordering vector O to have a binary representation and particularly to belong to the alphabet S.

Preferably, according to this invention, the input string B to the decoding method is a string obtained as an output string of the encoding method as hereinabove described.

More preferably, according to this invention, the deciphering function D(g) is the inverse function of the enciphering function E(m) of the encoding method.

It further subject-matter of this invention a processor comprising processing means, characterised in that it is adapted to perform the encoding method according to this invention.

It is further subject-matter of this invention a computer program characterised in that it includes code means adapted to perform, when they operate on a computer, the encoding method according to this invention.

It is further subject-matter of this invention a memory medium readable by a computer having a program stored therein, characterised in that the program is a computer program as above described.

It is additionally subject-matter of this invention a processor comprising processing means, characterised in that it is adapted to perform the decoding method according to this invention.

It is further subject-matter of this invention a computer program characterised in that it includes code means adapted to perform, when they operate on a computer, the decoding method according to this invention.

It is additionally subject-matter of this invention a memory medium readable by a computer having a program stored therein, characterised in that the program is a computer program as above described.

### BRIEF DESCRIPTION OF THE FIGURES

This invention will be now described by way of illustration and not by way of limitation according to its preferred embodiments, by particularly referring to the Figures of the annexed drawings, in which:

FIG. 1 shows a flow diagram of a preferred embodiment of the encoding method according to this invention;

FIG. 2 shows an input string A as scanned by the method of FIG. 1;

FIG. 3 shows the occurrence vector F (FIG. 3a), the ordered arrangement O (FIG. 3b) and the permutation vector P (FIG. 4c) considered in connection with the first item of the input string A from the method of FIG. 1;

FIG. 4 shows the occurrence vector F (FIG. 4a), the ordered arrangement vector O (FIG. 4b) and the permutation vector P (FIG. 4c) considered in connection with the second item of the input string A from the method of FIG. 1;

FIG. 5 shows the occurrence vector F (FIG. 5a), the ordered arrangement vector O (FIG. 5b) and the permutation vector P (FIG. 5c) considered in connection with the third item of the input string A from the method of FIG. 1;

FIG. 6 shows the occurrence vector F (FIG. 6a), the ordered arrangement vector O (FIG. 6b) and the permutation vector P (FIG. 6c) considered in connection with the fourth item of the input string A from the method of FIG. 1;

FIG. 7 shows the occurrence vector F (FIG. 7a), the ordered arrangement vector O (FIG. 7b) and the permutation vector P (FIG. 7c) considered in connection with the fifth item of the input string A from the method of FIG. 1;

FIG. 8 shows the occurrence vector F (FIG. 8a), the ordered arrangement vector O (FIG. 8b) and the permutation vector P (FIG. 8c) considered in connection with the sixth item of the input string A from the method of FIG. 1;

FIG. 9 shows the occurrence vector F (FIG. 9a), the ordered arrangement vector O (FIG. 9b) and the permutation vector P (FIG. 9c) considered in connection with the seventh item of the input string A from the method of FIG. 1; and

FIG. 10 shows the first seven items of the output string B obtained by the method of FIG. 1.

### DETAILED DESCRIPTION OF VARIOUS EMBODIMENTS

The encoding method according to this invention operates as a concentration filter, in view of the fact that it is adapted to evidence the correlations between the items of an input string A .

And, vice versa, the decoding method according to this invention is exactly complementary to the encoding method and it operates as a dispersion filter.

In particular, the reconstruction of a starting string A, by applying the decoding method to the string B, as obtained by means of the encoding method, is assured by the following property

pₒ_{ⱼ}=J, for j=0, 1, . . . , M−1

of the permutation vector P and by the fact that the deciphering function D(g) is the inverse function of the enciphering function E(m).

In similar way, it is apparent that it is possible to reconstruct a starting string B, by applying the encoding method to the string A, as obtained by applying the decoding method to the string B .

In particular, a preferred embodiment of the encoding method and of the decoding method according to this invention will be described below under the assumption that:

string A (input string for the encoding method and output string for the decoding method) and string B (output string for the encoding method and input string for the decoding method) are binary strings;

the symbols sₘ of the alphabet S are binary symbols comprising L bits (where L≧1, preferably L>1, and more preferably L>2);

the indexes hₗ of the ordered succession H, as shown in binary representation, are equal to the corresponding symbol sₗ of the alphabet S:

hₗ=sₗ; and

the indexes i of the items ƒᵢ of the occurrence vector F and indexes j of the items oⱼ of the ordered arrangement vector O belong to the alphabet S.

In this case, step D of the encoding method assigns to the item bₖ of the output string B the following symbol

bₖ=p_{E}(ₐ_{ₖ₎}

that, when the enciphering function E(m) is the identity function, becomes

bₖ=pₐ_{ₖ}.

In similar way, step J of the decoding method assigns to the item aₖ of the putput string A the symbol

aₖ=D(o_{b}_{ₖ})

that, when the deciphering function D(g) is the identity function, becomes

aₖ=o_{b}_{ₖ}.

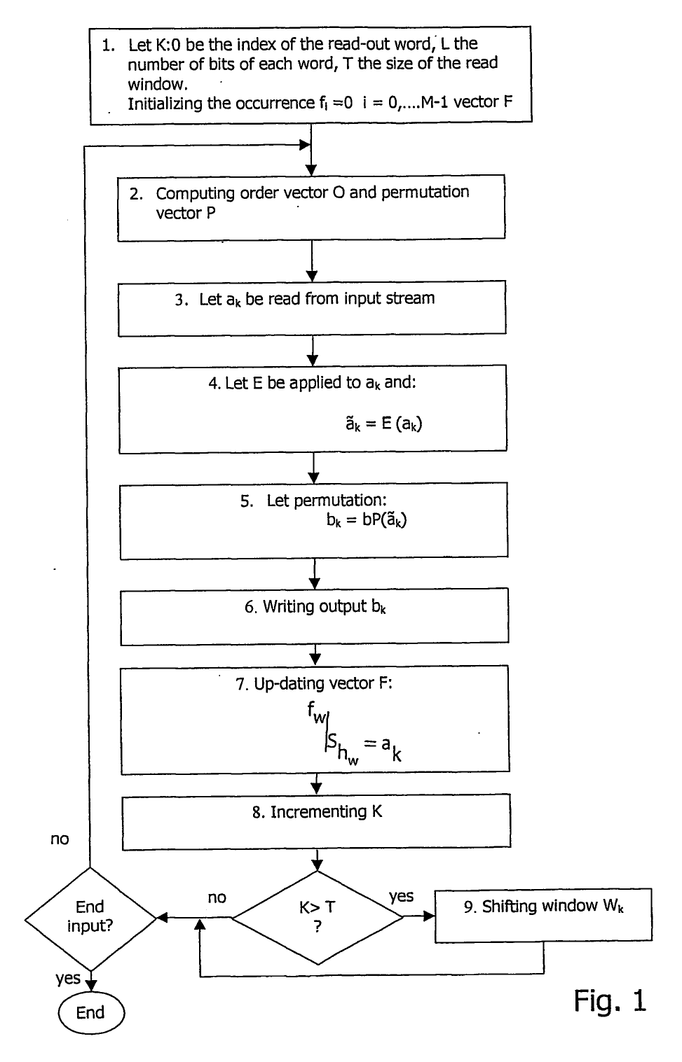

By referring to FIG. 1, which shows a flow diagram of a preferred embodiment of the coding method according to this invention, it is assumed that:

the symbols sₘ of the alphabet S are couple of bits, or the following four binary symbols having L=2:

S={“00”, “01”, “10”, “11”};

the ordered arrangement of the symbols sₘ of the alphabet S is coinciding with the binary digital value:

“00”, “01”, “10”, “11”:

portion Wₖ is a window containing, if existing, the T=5 consecutive items preceding the scanned item aₖ of the input string A; and

the enciphering function E(m) is the identity function.

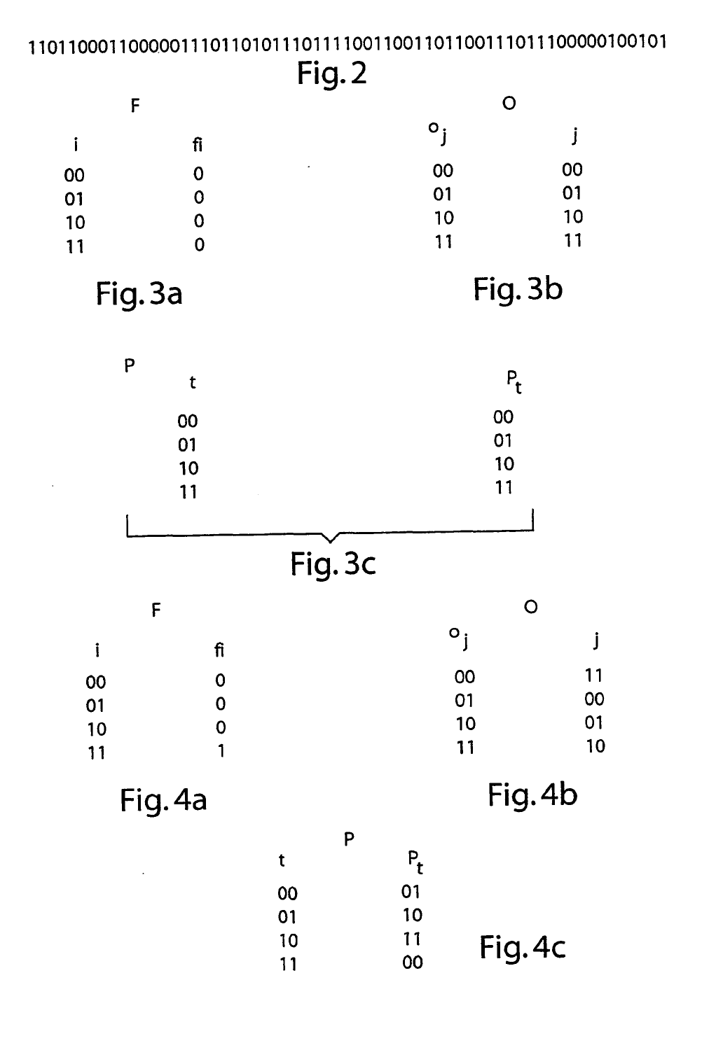

The input binary string A is the one shown in FIG. 2, where a₀=“11”, and the occurrence vector F is zeroed.

FIG. 3 shows the occurrence vector F (FIG. 3a), the ordered arrangement vector O (FIG. 3b) and the permutation vector P (FIG. 3c).

It is apparent that symbol b₀=pₐ_{₀}=“11” is assigned to the item of the output string B corresponding to a₀.

FIG. 4 shows the occurrence vector F (FIG. 4a), up-dated by the occurrence of symbol “11” in window W₁ related to the subsequently scanned item a₁=“01” of the input string A, and it also shows the new ordered arrangement vector O (FIG. 4b) as well as the new permutation vector P (FIG. 4c).

Symbol b₁=pₐ_{₁}=“10” is assigned to the item of the output string B corresponding to a₁.

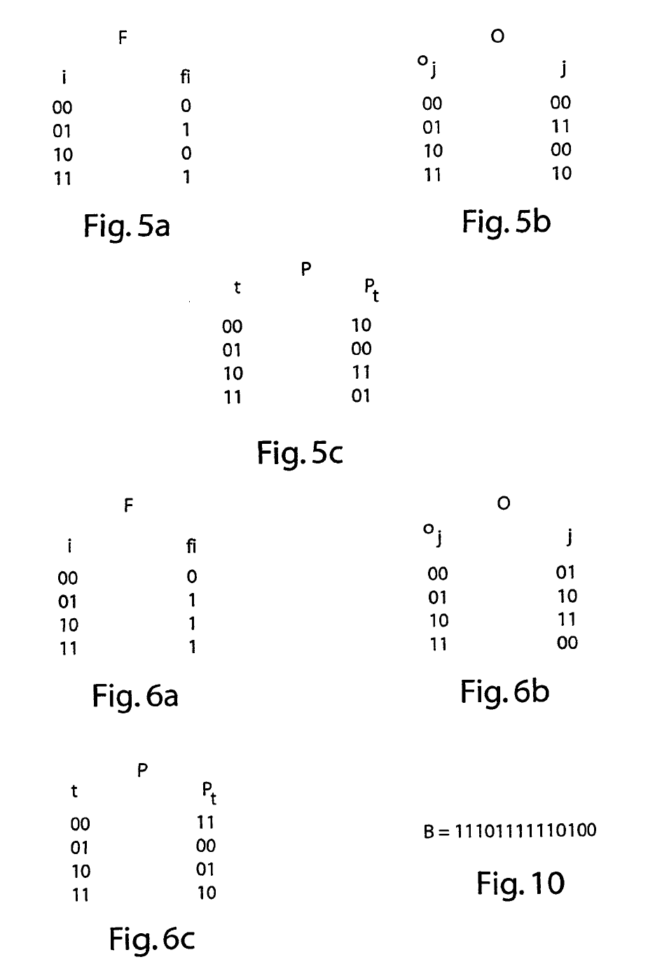

FIG. 5 shows the occurrence vector F (FIG. 5a), up-dated by the occurrence of symbol “01” in window W₂ related to the subsequently scanned item a₂=“10” of the input string A, and it also shows the new ordered arrangement vector O (FIG. 5b) as well as the new permutation vector P (FIG. 5c).

Symbol b₂=pₐ_{₂}=“11” is assigned to the item of the output string B corresponding to a₂.

FIG. 6 shows the occurrence vector F (FIG. 6a), up-dated by the occurrence of symbol “10” in window W₃ related to the subsequently scanned item a₃=“00” of the input string A, and it also shows the new ordered arrangement vector O (FIG. 6b) as well as the new permutation vector P (FIG. 6c).

Symbol b₃=pₐ_{₃}=“11” is assigned to the item of the output string B corresponding to a₃.

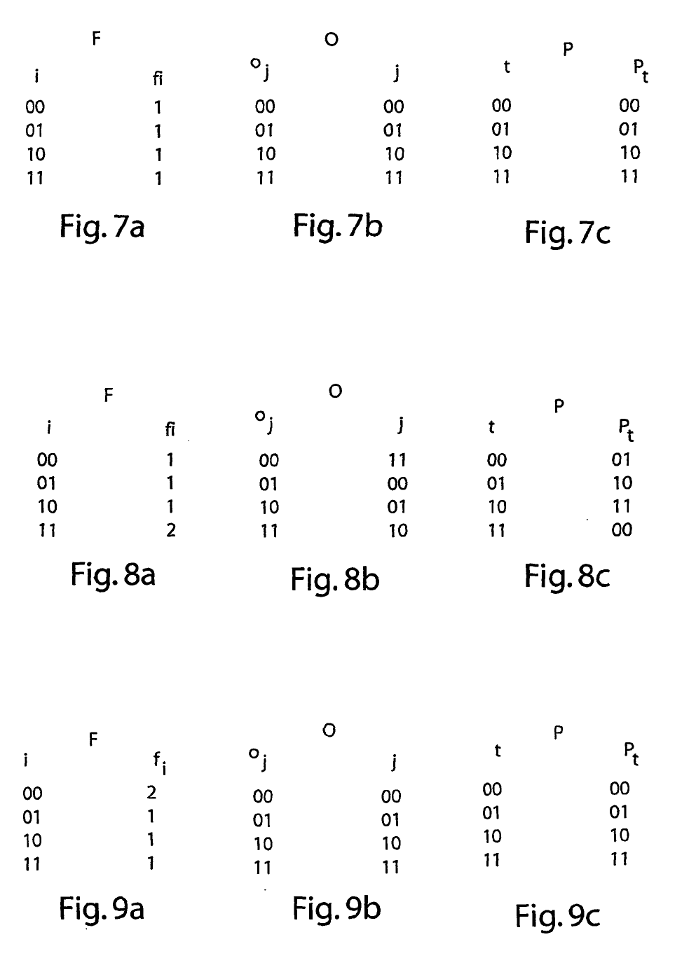

FIG. 7 shows the occurrence vector F (FIG. 7a), up-dated by the occurrence of symbol “00” in window W₄ related to the subsequently scanned item a₄=“11” of the input string A, and it also shows the new ordered arrangement vector O (FIG. 7b) as well as the new permutation vector P (FIG. 7c). Symbol b₄=Pₐ_{₄}=“11” is assigned to the item of the output string B corresponding to a₄.

FIG. 8 shows the occurrence vector F (FIG. 8a), up-dated by the further occurrence of symbol “11” in window W₅ related to the subsequently scanned item a₅=“00” of the input string A, and it also shows the new ordered arrangement vector O (FIG. 8b) as well as the new permutation vector P (FIG. 8c).

Symbol b₅=pₐ_{₅}=“01” is assigned to the item of the output string B corresponding to a₅.

FIG. 9a shows the occurrence vector F (FIG. 8a), up-dated by the further occurrence of symbol “00” in window W₆ and by the occurrence elimination of symbol “11” belonging to the item a₀ which was included in window W₅ but was not included in window W₆. Such window is related to the subsequently scanned item a₆=“00” of the input string A, in respect of which FIGS. 9b and 9c respectively show the new ordered arrangement vector O as well as the new permutation vector P.

Symbol b₆=pₐ_{₆}=“00” is assigned to the item of the output string B corresponding to a₆.

FIG. 10 shows the output string B as obtained up to b₆.

The encoding method continues computing the items bₖ of the output string B until the input string A is completely scanned. In particular, should the final bits of the input string A be not sufficient to reach the number of bits L for representing the symbols sₘ of the alphabet S, the method can alternatively copy them at the end of the output string or fill the bits lacking to L with arbitrary bits (for instance a tail of “0”'s) and carry out an encoding operation of the symbol sₘ as obtained by means of such filling operation.

It is apparent that the ordered arrangement of the symbols sₘ of the alphabet S can be arbitrary, rather than coinciding with the binary numeric value, as shown in FIGS. 2-10.

The effect generated by utilising an enciphering function E(m) different from the identity function is to introduce a further permutation between the read out items and the encoded ones.

As above the, it is possible to utilise enciphering functions of different forms that should

be invertible, in order to make the input string recoverable, by applying the decoding method according to the invention to the output string, and

have coincident dominion and co-dominion, in order that the permutation function be existing for each value of the independent variable.

To all application purposes of cryptography, it is advantageous for the enciphering function E(m) to be a function with memory, by making the value calculated at a given step depending on all previous values which obviously depend on what has been scanned up to the previous step.

Only by way of exemplification and not by way of limitation, a function adapted to generate pseudo random values (whose statistical behaviour is similar to a noise function) could be utilised as enciphering function E(m), the pseudo random values being dependant, in particular, on one or more initial values or seeds. Such kind of functions should allow to generate acyclic sequences as long as possible, in order to assure an high level of introduced noise, such as to make any Reverse Engineering attempt even more complex. Examples of pseudo random value generating functions can be the linear congruence functions (or Lehmer functions).

It should be immediately understood by those skilled in the art that both the encoding method and the decoding method according to this invention are iteratable a number of times, by construing each time the obtained output string as a new input string.

The preferred embodiments of this invention have been described and a number of variations have been suggested hereinbefore, but it should expressly be understood that those skilled in the art can make other variations and changes, without so departing from the scope thereof, as defined in the following claims.

1. A method for encoding an input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the method comprising the steps of:
A. providing an ordered arrangement of the M symbols sₘ of the alphabet S as represented by a corresponding ordered succession H={hₗ, where l=1, . . . , M−1} of the indexes m, such that
hₗε{0, 1, . . . , M−1}
h_{q}≠hᵣ for q≠r,
in that a scanning operation is carried out on items aₙ of the input string A and in that, for each of the items aₖ, where k ε{0, 1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1},
where
H={h₀, . . . , hᵤ, . . . , hᵥ, . . . , h_{M-1}}
C. establishing a permutation vector P consisting of M items pₜ, where t=0, 1, . . . , M−1, whose items are such as to fulfil the following relationship
pₒ_{ⱼ}=j for j=0, 1, . . . , M−1
and
D. assigning to item bₖ of the output string B the symbol
bₖ=s_{E}(ₕ_{_{pt=w}})
where w is the w-th index h_{w} of the ordered succession H such as to fulfil the relationship
aₖ=sₕ_{_{w}}
and the enciphering function E(m) is an invertible function whose dominion and co-dominion are coinciding and are equal to the assembly {0, 1, . . . , M−1}:
$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

2. A method according to claim 1, wherein the at least a portion Wₖ of Tₖ items aₙ of the input string A is different by at least two items aₖ_{₁}, and aₖ_{₂} as scanned in the input string A.

3. A method according to claim 2, wherein the number Tₖ of items aₙ belonging to the at least a portion Wₖ is different by at least two items aₖ_{₁}, and aₖ_{₂} as scanned in the input string A.

4. A method according to claim 1 further comprising the step of:
E. zeroing the M items ƒᵢ, where i=1, . . . , M−1, of the occurrence vector F:
ƒᵢ=0, for i=0, 1, . . . , M−1.

5. A method according to claim 4 wherein for each of the items aₖ, with k ε{0, 1, . . . , N−1} it further includes the following step:
F. up-dating the occurrence vector F.

6. A method according to claim 1 wherein the number Tₖ of items aₙ belonging to the at least a portion Wₖ is not higher than a constant value T for all items aₖ, where k ε{0, 1, . . . , N−1}, as scanned by the input string A:
Tₖ≦T,
where
k=0, 1, . . . , N−1.

7. A method according to claim 6, wherein the at least a portion Wₖ is a sub-string of Tₖ consecutive items aₙ of the input string A.

8. A method according to claim 7, wherein the at least a portion Wₖ is a sub-string of Tₖ consecutive items aₙ of the input string A, whose last item is the item aₖ₋₁ preceding the scanned item aₖ:
Wₖ={a_{k-T}ₖ, a_{k-T}_{ₖ}₊₁, . . . , aₖ₋₁}.

9. A method according to claim 1 wherein the number Tₖ of items aₙ belonging to the at least a portion Wₖ is constant for all items aₖ, where k ε{0, 1, . . . , N−1}, as scanned in the input string A:
Tₖ=T,
where
k=0, 1, . . . , N−1.

10. A method according to claim 1 wherein, for at least one of the scanned items aₖ, the at least a portion Wₖ coincides with the input string A:
Wₖ=A.

11. A method according to claim 1 wherein the scanning operation of the items aₖ of the input string A is progressive, so that items aₖ, where k=0, 1, . . . , N−1, are successively scanned.

12. A method according to claim 1 wherein the items aₙ of the input string A belong to a sub-assembly S_{A} of the alphabet S, such that S_{A}⊂S, and the items bₙ of the output string B belong to a sub-assembly S_{B} of the alphabet S, such that S_{B}⊂S, the sub-assembly S_{A} being different from the sub-assembly S_{B}:
S_{A}≠S_{B}.

13. A method according to claim 1 wherein the enciphering function E(m) is a function with memory, so that the n-th computed value gₙ=E(m) depends on Z previously computed values:
gₙ=E(m, gₑ_{₁}, gₑ_{₂}, . . . gₑ_{_{z}}),
where Z≧1.

14. A method according to claim 13 wherein the enciphering function E(m) is a pseudo-random value generating function.

15. A method according to claim 1 wherein the enciphering function E(m) is the identity function:
g=E(m)=m.

16. A method according to claim 1 wherein the input string A and the output string B are binary strings, the symbols sₘ of the alphabet S being binary symbols comprising L bits, where L≧1.

17. A method according to claim 16 wherein the indexes hₗ of the ordered succession H have a binary representation.

18. A method according to claim 17 wherein the indexes hₗ of the ordered succession H are equal to the corresponding symbol sₗ of the alphabet S:
hₗ=Sₗ.

19. A method according to claim 17 wherein the indexes i of the items ƒᵢ of the occurrence vector F as well as the indexes j of the items oⱼ of the ordered arrangement vector O have a binary representation.

20. A method according to claim 19 wherein the indexes i of the items ƒᵢ of the occurrence vector F as well as the indexes j of the items oⱼ of the ordered arrangement vector O belong to the alphabet S.

21. A method for decoding an input string B into an output string A, both the input string B and the output string A comprising N items, respectively, bₙ and aₙ, where n=0, 1, . . . , N−1, with items bₙ and aₙ belonging to an alphabet S of M symbols sₘ, where m=0, 1, . . . , M−1, the method comprising the steps of:
A. providing an ordered arrangement of the M symbols sₘ of alphabet S represented by a corresponding ordered succession H={hₗ, where l=0, 1, . . . , M−1} of the indexes m, such that
hₗε{0,1, . . . , M−1}
h_{q}≠hᵣ, for q≠r,
in that a scanning operation of items bₙ of the input string B is carried out and in that, for each of the items bₖ, where k ε{0,1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ previously calculated items aₙ of the output string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the ordered arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z}}+, o_{z}=u<v=o_{z+1},
where
H={h₀, . . . , hᵤ, . . . , hᵥ, . . . , h_{M-1}}
and
C. assigning to item aₖ of the output string A the symbol
aₖ=s_{D}(ₕ_{_{oj=w}})
where w is the w-th index h_{w} of the ordered succession H such as to fulfil the relationship
bₖ=sₕ_{_{w}}
and the deciphering function D(g) is an invertible function whose dominion and co-dominion are coinciding and are equal to the assembly {0, 1, . . . , M−1}:
$$\{ \begin{matrix}m = D ( g ) ∈ \{ 0 , 1 , … , M - 1 \} \\ g = E ( m ) = {D}^{- 1} ( m ) = ∈ \{ 0 , 1 , … , M - 1 \}\end{matrix} .$$

22. A method according to claim 21 wherein the at least a portion Wₖ of Tₖ items aₙ of the output string A is different by at least two items bₖ_{₁} and bₖ_{₂} as scanned in the input string B.

23. A method according to claim 22 wherein the number Tₖ of items aₙ belonging to the at least a portion Wₖ is different by at least two items bₖ_{₁} and bₖ_{₂} as scanned in the input string B.

24. A method according to claim 21 further comprising the step, prior to scanning, of:
D. zeroing the M items ƒᵢ, where i=1, . . . , M−1, of the occurrence vector F:
ƒᵢ=0, for i=0, 1, . . . , M−1.

25. A method according to claim 22 wherein for each of the items bₖ, with k ε{0, 1, . . . , N−1}, further comprising the step of:
E. up-dating the occurrence vector F.

26. A method according to claim 21 wherein the number Tₖ of items aₙ belonging to the at least a portion Wₖ is not higher than a constant value T for all items bₖ, where k ε{0, 1, . . . , N−1}, as scanned by the input string B:
Tₖ≦T,
where
k=0, 1, . . . , N−1.

27. A method according to claim 26 wherein the at least a portion Wₖ is a sub-string of Tₖ consecutive items aₙ of the output string A.

28. A method according to claim 27 wherein the at least a portion Wₖ is a sub-string of Tₖ consecutive items aₙ of the output string A whose last item is the item aₖ₋₁ as calculated for the scanned item bₖ preceding the scanned item bₖ of the input string B:
Wₖ={a_{k-T}_{ₖ}, a_{k-T}_{ₖ}₊₁, . . . , aₖ₋₁}.

29. A method according to claim 21 wherein the number Tₖ of items aₙ belonging to the at least a portion Wₖ is constant for all items bₖ, where k ε{0, 1, . . . , N−1}, as scanned in the input string B:
Tₖ=T,
where
k=0, 1, . . . , N−1.

30. A method according to claim 21 wherein the scanning operation of items bₙ of the input string B is progressive, so that items bₖ where k=0, 1, . . . , N−1 are successively scanned.

31. A method according to claim 21 wherein the items bₙ of the input string B belong to a sub-assembly S_{B} of the alphabet S, such that S_{B}⊂S, and the items aₙ of the output string A belong to a sub-assembly S_{A} of the alphabet S, such that S_{A}⊂S, the sub-assembly S_{B} being different from the sub-assembly S_{A}:
S_{B}≠S_{A}.

32. A method according to claim 21 wherein the deciphering function D(g) is a function with memory, so that the n-th computed value mₙ=D(g) depends on J previously computed values:
mₙ=D(g, m_{c}_{₁}, m_{c}_{₂}, . . . , m_{c}_{ⱼ}),
where J≧1.

33. A method according to claim 21 wherein the deciphering function D(g) is the inverse function of a pseudo-random value generating function.

34. A method according to claim 21 wherein the deciphering function D(g) is the identity function:
m=D(g)=g.

35. A method according to claim 21 wherein the input string B and the output string A are binary strings, the symbols sₘ of the alphabet S being binary symbols comprising L bits, where L≧1.

36. A method according to claim 35 wherein the indexes hₗ of the ordered succession H have a binary representation.

37. A method according to claim 36 wherein the indexes hₗ of the ordered succession H are equal to the corresponding symbol Sₗ of the alphabet S:
hₗ=sₗ.

38. A method according to claim 36 wherein the indexes i of the items ƒᵢ of the occurrence vector F as well as the indexes j of the items oⱼ of the ordered arrangement vector O have a binary representation.

39. A method according to claim 38 wherein the indexes i of the items ƒᵢ of the occurrence vector F as well as the indexes j of the items oⱼ of the ordered arrangement vector O belong to the alphabet S.

40. A method according to claim 21 wherein the input string B is a string obtained as an output string of a method for encoding an input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the method for encoding comprising the steps of:
D. providing an ordered arrangement of the M symbols sₘ of the alphabet S as represented by a corresponding ordered succession H={hₗ, where l=1, . . . , M−1} of the indexes m, such that
hₗε{0, 1, . . . , M−1}
h_{q}≠hᵣ for q≠r,
in that a scanning operation is carried out on items aₙ of the input string A and in that, for each of the items aₖ, where k ε{0, 1, . . . , N−1}, it includes the following steps:
E. arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1},
where
H={h₀, . . . , hᵤ, . . . , hᵥ, . . . , h_{M-1}}
F. establishing a permutation vector P consisting of M items pₜ, where t=0, 1, . . . , M−1, whose items are such as to fulfil the following relationship
pₒ_{ⱼ}=j for j=0, 1, . . . , M−1
and
G. assigning to item bₖ of the output string B the symbol
bₖ=s_{E}(ₕ_{_{pt=w}})
where w is the w-th index h_{w} of the ordered succession H such as to fulfil the relationship
aₖ=sₕ_{_{w}}
and the enciphering function E(m) is an invertible function whose dominion and co-dominion are coinciding and are equal to the assembly {0, 1, . . . , M−1}:
$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

41. A method according to claim 40, characterised in that the deciphering function D(g) is the inverse function of the enciphering function E(m) of the encoding method.

42. A processor comprising processing means for performing the following steps of encoding of input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the processor performing the steps of:
A. providing an ordered arrangement of the M symbols sₘ of the alphabet S as represented by a corresponding ordered succession H={hₗ, where l=1, . . . , M−1} of the indexes m, such that
hₗε{0, 1, . . . , M−1}
h_{q}≠hᵣ for q≠r,
in that a scanning operation is carried out on items aₙ of the input string A and in that, for each of the items aₖ, where k ε{0, 1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1},
where
H={h₀, . . . , hᵤ, . . . , hᵥ, . . . , h_{M-1}}
C. establishing a permutation vector P consisting of M items pₜ, where t=0, 1, . . . , M−1, whose items are such as to fulfil the following relationship
pₒ_{ⱼ}=j for j=0, 1, . . . , M−1
and
D. assigning to item bₖ of the output string B the symbol
bₖ=s_{E}(ₕ_{_{pt=w}})
where w is the w-th index h_{w} of the ordered succession H such as to fulfil the relationship
aₖ=sₕ_{_{w}}
and the enciphering function E(m) is an invertible function whose dominion and co-dominion are coinciding and are equal to the assembly {0, 1, . . . , M−1}:
$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

43. A computer program operating on a computer, the program comprising means for encoding an input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the means comprising:
means for providing an ordered arrangement of the M symbols sₘ of the alphabet S as represented by a corresponding ordered succession H={hₗ, where l=1, . . . , M−1} of the indexes m, such that
hₗε{0, 1, . . . , M−1}
h_{q}≠hᵣ for q≠r,
in that a scanning operation is carried out on items aₙ of the input string A and in that, for each of the items aₖ, where k ε{0, 1, . . . , N−1}, it includes the following steps:
arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1}, where H={h₀, . . . , hᵤ, . . . , hᵥ, . . . , h_{M-1}}
establishing a permutation vector P consisting of M items pₜ, where t=0, 1, . . . , M−1, whose items are such as to fulfil the following relationship
pₒ_{ⱼ}=j for j=0, 1, . . . , M−1
and
assigning to item bₖ of the output string B the symbol
bₖ=s_{E}(ₕ_{_{pt=w}})
where w is the w-th index h_{w} of the ordered succession H such as to fulfil the relationship
aₖ=sₕ_{_{w}}
and the enciphering function E(m) is an invertible function whose dominion and co-dominion are coinciding and are equal to the assembly {0, 1, . . . , M−1}:
$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

44. A memory medium readable by a computer having a program stored therein, the medium comprising code implementing a method for encoding an input string A into an output string B, both the input string A and the output string B comprising N items, respectively, aₙ and bₙ, where n=0, 1, . . . , N−1, with items aₙ and bₙ belonging to an alphabet S of M symbols sₘ, where m=0, 1, . . . , M−1, the medium comprising:
code for instructing a processor to provide providing an ordered arrangement of the M symbols sₘ of the alphabet S as represented by a corresponding ordered succession H={hₗ, where l=1, . . . , M−1} of the indexes m, such that
hₗε{0, 1, . . . , M−1}
h_{q}≠hᵣ for q≠r,
in that a scanning operation is carried out on items aₙ of the input string A and in that, for each of the items aₖ, where k ε{0, 1, . . . , N−1}, it includes the following steps:
arranging in decreasing order the M items ƒᵢ, where i=0, 1, . . . , M−1, of an occurrence vector F of the symbols sₘ of the alphabet S in at least a portion Wₖ⊂A of Tₖ items aₙ of the input string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1}, where H={h₀, . . . , hᵤ, . . . , hᵥ, . . . , h_{M-1}}
establishing a permutation vector P consisting of M items pₜ, where t=0, 1, . . . , M−1, whose items are such as to fulfil the following relationship
pₒ_{ⱼ}=j for j=0, 1, . . . , M−1
and
assigning to item bₖ of the output string B the symbol
bₖ=s_{E}(ₕ_{_{pt=w}})
where w is the w-th index h_{w} of the ordered succession H such as to fulfil the relationship
aₖ=sₕ_{_{w}}
and the enciphering function E(m) is an invertible function whose dominion and co-dominion are coinciding and are equal to the assembly {0, 1, . . . , M−1}:
$$\{ \begin{matrix}g = E ( m ) ∈ \{ 0 , 1 , … , M - 1 \} \\ m = D ( g ) = {E}^{- 1} ( g ) ∈ \{ 0 , 1 , … , M - 1 \}\end{matrix} .$$

45. A processor comprising processing means for performing a method for decoding an input string B into an output string A, both the input string B and the output string A comprising N items, respectively, bₙ and aₙ, where n=0, 1, . . . , N−1, with items bₙ and aₙ belonging to an alphabet S of M symbols sₘ, where m=0, 1, . . . , M−1, the processor comprising means for:
A. providing an ordered arrangement of the M symbols sₘ of alphabet S represented by a corresponding ordered succession H={hₗ, where l=0, 1, . . . , M−1} of the indexes m, such that
hₗε{0,1, . . . , M−1}
h_{q}≠hᵣ, for q≠r,
in that a scanning operation of items bₙ of the input string B is carried out and in that, for each of the items bₖ, where k ε{0,1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ previously calculated items aₙ of the output string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the ordered arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1}, where H={h₀, . . . , hᵤ, . . . , hᵥ, . . . , h_{M-1}}
and
C. assigning to item aₖ of the output string A the symbol
aₖ=s_{D}(ₕ_{_{oj=w}})
where w is the w-th index h_{w} of the ordered succession H such as to fulfil the relationship
bₖ=sₕ_{_{w}}
and the deciphering function D(g) is an invertible function whose dominion and co-dominion are coinciding and are equal to the assembly {0, 1, . . . , M−1}:
$$\{ \begin{matrix}m = D ( g ) ∈ \{ 0 , 1 , … , M - 1 \} \\ g = E ( m ) = {D}^{- 1} ( m ) ∈ \{ 0 , 1 , … , M - 1 \}\end{matrix} .$$

46. A computer program operable on a computer that includes code means to perform method for decoding an input string B into an output string A, both the input string B and the output string A comprising N items, respectively, bₙ and aₙ, where n=0, 1, . . . , N−1, with items bₙ and aₙ belonging to an alphabet S of M symbols sₘ, where m=0, 1, . . . , M−1, the computer program comprising code means for:
A. providing an ordered arrangement of the M symbols sₘ of alphabet S represented by a corresponding ordered succession H={hₗ, where l=0, 1, . . . , M−1} of the indexes m, such that
hₗε{0,1, . . . , M−1}
h_{q}≠hᵣ, for q≠r,
in that a scanning operation of items bₙ of the input string B is carried out and in that, for each of the items bₖ, where k ε{0,1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ previously calculated items aₙ of the output string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the ordered arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1}, where H={h₀, . . . , hᵤ, . . . , hᵥ, . . . , h_{M-1}}
and
C. assigning to item aₖ of the output string A the symbol
aₖ=s_{D}(ₕ_{_{oj=w}})
where w is the w-th index h_{w} of the ordered succession H such as to fulfil the relationship
bₖ=sₕ_{_{w}}
and the deciphering function D(g) is an invertible function whose dominion and co-dominion are coinciding and are equal to the assembly {0, 1, . . . , M−1}:
$$\{ \begin{matrix}m = D ( g ) ∈ \{ 0 , 1 , … , M - 1 \} \\ g = E ( m ) = {D}^{- 1} ( m ) ∈ \{ 0 , 1 , … , M - 1 \}\end{matrix} .$$

47. A memory medium readable by a computer having a program stored therein, the memory medium comprising code means for implementing a method for decoding an input string B into an output string A, both the input string B and the output string A comprising N items, respectively, bₙ and aₙ, where n=0, 1, . . . , N−1, with items bₙ and aₙ belonging to an alphabet S of M symbols sₘ, where m=0, 1, . . . , M−1, the memory medium comprising code means for:
A. providing an ordered arrangement of the M symbols sₘ of alphabet S represented by a corresponding ordered succession H={hₗ, where l=0, 1, . . . , M−1} of the indexes m, such that
hₗε{0,1, . . . , M−1}
h_{q}≠hᵣ, for q≠r,
in that a scanning operation of items bₙ of the input string B is carried out and in that, for each of the items bₖ, where k ε{0,1, . . . , N−1}, it includes the following steps:
B. arranging in decreasing order the M items ƒᵢ, where i=0, 1, . . . , M−1, of an occurrence vector F of the symbols sₘ of the alphabet S in at least a portion Wₖ⊂A of Tₖ previously calculated items aₙ of the output string A, where Tₖ≧0, each item ƒᵢ being equal to the number of occurrences in portion Wₖ of the corresponding symbol sₕ_{ᵢ}, in respect of which the following relationship is fulfilled:
$${\sum }_{i = 0}^{M - 1} {f}_{i} = {T}_{k} ,$$
the items ƒᵢ of the occurrence vector F being arranged in an ordered arrangement vector O comprising M items oⱼ, where j=0, 1, . . . , M−1, whose items oⱼ include the indexes i of items ƒᵢ of vector F arranged in decreasing order, by employing, when two items ƒᵢ are equal, the ordered arrangement of the symbols sₘ of the alphabet S, as represented by the corresponding ordered arrangement H, such that
ƒₒ_{ₓ}≧ƒₒ_{_{y}}, ∀y>x
and
for ƒₒ_{_{z}}=ƒₒ_{_{z+1}}, o_{z}=u<v=o_{z+1},
where
H={h₀, . . . , hᵤ, . . . , hᵥ, . . ., h_{M-1}}
and
C. assigning to item aₖ of the output string A the symbol
aₖ=s_{D}(ₕ_{_{oj=w}})
where w is the w-th index h_{w} of the ordered succession H such as to fulfil the relationship
bₖ=sₕ_{_{w}}
and the deciphering function D(g) is an invertible function whose dominion and co-dominion are coinciding and are equal to the assembly {0, 1, . . . , M−1}:
$$\{ \begin{matrix}m = D ( g ) ∈ \{ 0 , 1 , … , M - 1 \} \\ g = E ( m ) = {D}^{- 1} ( m ) = ∈ \{ 0 , 1 , … , M - 1 \}\end{matrix} .$$
